(19) United States
(12) Patent Application Publication
(10) Pub. No.: US 2018/0374068 A1
(43) Pub. Date: Dec. 27, 2018

(54) PAYMENT TERMINAL AND RELATED PRODUCT AND / OR SERVICE MANAGEMENT SYSTEM

(71) Applicant: PARKEON, Paris (FR)

(72) Inventors: Julien MOLÉ, ARBOIS (FR); David LAGNIE, OSSELLE-ROUTELLE (FR); Alexandre MAUREL, BESANCON (US); Franck MARTINEZ, EMAGNY (FR)

(21) Appl. No.: 16/013,221

(22) Filed: Jun. 20, 2018

(30) Foreign Application Priority Data
Jun. 21, 2017 (FR) 17 55665

(51) Int. Cl. G06Q 20/18; H04W 4/14

(52) U.S. Cl. CPC G06Q 20/18; H04L 51/10; G06Q 2240/00; H04W 4/14

(57) ABSTRACT

The self-service pay station is arranged on the road for the purchase of a product and/or service. The pay station is configured to be connected to a remote computer system connected to several similar pay stations of a system for managing a product and/or service. The pay station comprises an alert system configured to allow a pedestrian to generate an alert message, the pay station being configured to send the alert message to the computer system.

### TECHNICAL FIELD

The present invention relates to the field of self-service pay stations located in public areas for the sale of a product and/or service.

### BACKGROUND

FR 2,968,814 A1 discloses a parking ticket machine configured to provide a paying service to send a message of the SMS (Shortcut Message System), MMS (Multimedia Messaging Service) or email type, the message potentially being accompanied by an image, video or audio content captured by a capture device of the parking ticket machine or received by the parking ticket machine via a communication device at a short distance from the parking ticket machine.

### SUMMARY

One of the aims of the invention is to propose a pay station offering an additional functionality.

To that end, the invention proposes a self-service pay station arranged on a road to purchase a product and/or a service, the pay station being configured to be connected to a remote computer system connected to several similar pay stations of a system for managing a product and/or service, the pay station comprising an alert system configured to allow a pedestrian to generate an alert message, the pay station being configured to send the alert message to the computer system.

A pay station arranged on a road can provide advantageous support for an alert system, in particular because a pay station is supplied with power, it is in communication with a remote computer system in order to sell the product and/or service, and the pay station is part of a network of pay stations distributed on the road. In particular, the pay stations delivering parking tickets make up a relatively dense network, in particular in cities. The pay stations are therefore quickly accessible. An alert message for example relates to an incident or traffic accident, an attack, a fire, etc., and more generally any event that may require a civilian protection intervention (police, relief, etc.).

In specific embodiments, the pay station may comprise one or several of the following optional features, considered alone or according to all technically possible combinations:
the alert system comprises an alert member able to be actuated manually by a pedestrian to generate an alert message;
the alert system comprises a touch-sensitive screen able to be used by a pedestrian to generate an alert message;
the alert system comprises a capture device able to capture sounds, the pay station being configured to attach audio content to the alert message and/or to establish an audio communication with a remote operator;
the alert system comprises a capture device able to capture images, the pay station being configured to attach video content to the alert message and/or to establish a video communication with a remote operator;
the alert system comprises a biometrics module, the pay station being configured to determine biometric data, and to attach biometric data to the alert message and/or to identify a pedestrian using the alert system;
the pay station comprises a signal generator configured to emit a visual, audio and/or olfactory alert signal perceptible by pedestrians and/or passengers of vehicles near the pay station;
the pay station comprises a communication device configured to broadcast the alert message to electronic devices belonging to pedestrians, vehicle passengers and/or vehicles located near the pay station, via a radio or optical communication link

The invention also relates to a system for managing a product and/or service, comprising a plurality of pay stations, each pay station being as defined above, a computer system in communication with each pay station, the computer system being configured to broadcast each alert message sent by a pay station to one or several predetermined recipient(s).

In one embodiment, the predetermined recipient(s) are or comprise: one or several providers of road traffic data, one or several civilian safety entities and/or one or several pay stations from among the other pay stations of the management system.

### BRIEF DESCRIPTION OF DRAWINGS

The invention and its advantages will be better understood upon reading the following description, provided solely as a non-limiting example, and done in reference to the appended drawings, in which:

FIG. 1 is a schematic overview of a system for managing a product and/or service comprising a plurality of self-service pay stations arranged on the road;

FIG. 2 is a flowchart illustrating the steps of a method for broadcasting an alert message carried out using the management system of FIG. 1.

### DETAILED DESCRIPTION OF PREFERRED EMBODIMENTS

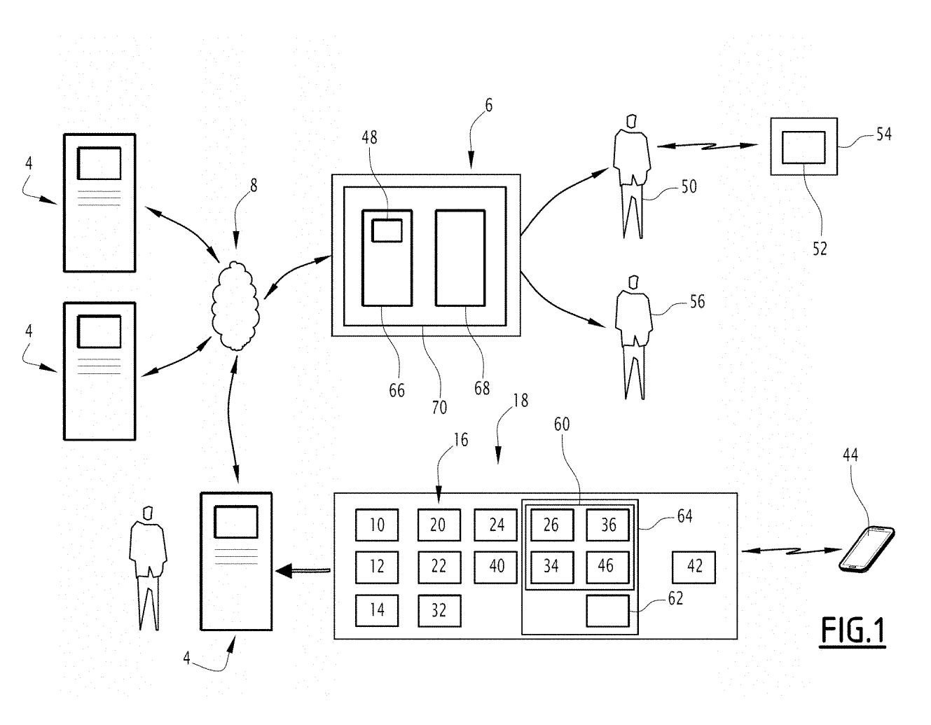

As illustrated in FIG. 1, the system 2 for managing a product and/or service is configured to allow users to purchase a product and/or service using a plurality of self-service pay stations 4 arranged on the road.

The management system 2 comprises a central computer system 6 in communication with each of the pay stations 4 via a communication network 8.

In the present description, a “user” refers to a person using a pay station 4 of the management system 2 to purchase a product and/or service, while a “pedestrian” or “passerby” refers to a person not using the pay station 4 to purchase a product and/or service, but who may be located on the road near the pay station 4.

Furthermore, the “road” comprises the street, on the one hand, reserved for motor traffic, and on the other hand, the pedestrian areas (sidewalks and squares, etc.), reserved for pedestrian traffic.

In the illustrated example, each pay station 4 is a parking ticket machine, configured to issue parking documents, authorizing the user to park his vehicle in a parking place. Alternatively, each parking terminal 4 is configured to issue parking documents making it possible to use public transportation (bus, subway, tram, train, etc.).

The communication network 8 is a wired or wireless communication network. The communication network 8 is for example a wired telephone network, a mobile telephone network (GSM, UMTS, LTE, etc.), a computer network (LAN, WAN), the Internet, a local network (Wi-Fi, Bluetooth, Lora, Li-Fi, Zigbee, Z-Wave, Dust, ANT+, NFC, etc.), etc.

The pay stations 4 are similar.

Each pay station 4 comprises a man-machine interface device 10 allowing the user to interact with the pay station 4 in order to purchase a product and/or service. The man-machine interface device 10 for example allows the user to select a product and/or service that he wishes to purchase.

The man-machine interface device 10 for example comprises an image display device, a pointing device for selecting fields and/or buttons in a user graphic interface, an alphanumeric keypad for entering alphanumeric characters and/or one or several physical buttons. The image display device is for example a screen, in particular a touch-sensitive screen to make it possible to point to and/or enter data directly on the screen.

Each pay station 4 comprises a payment device 12 allowing a user to pay for a product and/or service using the pay station 4.

The payment device 12 for example comprises an electronic payment terminal configured for payment by payment card, in particular by bank or private card, a coin selector configured for payment with one or several coins, a banknote reader configured for payment with one or several banknotes, a contactless pay station configured for payment with an electronic device (chip card, smartphone, etc.) with contactless communication with the contactless pay station and the electronic device, for example by near-field communication (NFC), and/or a printing device for printing a receipt, for example a parking ticket or transportation document.

Each pay station 4 is configured to exchange data with the computer system 6 to carry out a transaction relative to the purchase of a product and/or service by a user using the pay station 4.

Each pay station 4 comprises a communication device 14 using which the pay station 4 is in communication with the computer system 6 via the communication network 8.

Each pay station 4 comprises an alert system 16 borne by the pay station 4 and configured to allow a pedestrian to generate and send an alert message to the computer system 6. The alert system 16 can be used independently of the purchase of a product and/or service using the pay station 4.

The alert system 16 comprises an alert interface device 18 configured to allow a pedestrian to interact with the pay station 4 to generate an alert message.

The alert interface device 18 comprises one or several interface element(s) able to be actuated by the pedestrian to generate an alert message.

The alert interface device 18 for example comprises a mobile alert member 20 able to be actuated manually by a pedestrian to generate an alert message. The mobile alert member 20 is for example a push button, a toggle switch, a lever, a pull-lever, etc. In one particular embodiment, the mobile alert member 20 is a push button.

Alternatively or optionally, the alert interface device 18 comprises a touch-sensitive screen 22 configured to display a graphic user interface allowing a pedestrian to generate an alert message.

Optionally, the alert system 16 comprises a capture device 24 configured to capture sound and/or images.

The capture device 24 for example makes it possible to record audio content that can be attached to the alert message and/or to place the pedestrian in audio communication with the computer system 6 and/or with an operator.

The capture device 24 for example makes it possible to record video content that can be attached to an alert message and/or to place the pedestrian in video communication with the computer system 6 and/or with an operator.

Optionally, the alert system 16 comprises an analysis module 26 configured to analyze sound and/or images captured by the capture device 24. The analysis module 26 is for example configured to calculate a voice imprint, analyze the voice of the person using the alert system 16, calculate a facial imprint, calculate a retinal imprint and/or analyze the behavior of one or several people in images.

The analysis of the voice in an audio recording and/or the behavioral analysis in images for example makes it possible to assess whether the person is actually in a stressful situation due to events causing him to generate an alert message.

Optionally, the alert system 16 comprises an emergency call device 32 configured to establish an audio and/or video communication between the pay station 4 and a remote operator.

The pay station 4 is thus configured also to serve as an emergency call terminal, making it possible to place the person generating the alert message in contact with an operator.

The call to the operator is for example made using the computer system 6 and the communication network 8. The emergency call device 32 is for example configured to use the sounds and/or images captured by the capture device 24.

Alternatively or optionally, the alert system 16 comprises a biometrics module 34 configured to calculate biometric data, in particular relative to a person using the alert system 16.

The biometrics module 34 is configured to calculate a digital imprint, a palm imprint, a facial imprint, a retinal imprint and/or a voice imprint.

Like in the illustrated example, the biometrics module 34 can use sounds and/or images provided by the capture device 24 to calculate one or several input(s) from among those mentioned above.

Alternatively or optionally, the biometrics module 34 is associated with one or several dedicated biometric sensor(s) distinct of the capture device 24, for example a fingerprint sensor, a palm imprint sensor, a facial imprint sensor, a retinal imprint sensor and/or a voice imprint sensor.

The captured biometric data can be used to identify people visible in the images or whose voice is present in audio recordings captured by the alert system 16 during the use of the latter.

Optionally, the alert system 16 comprises an identification module 36 configured to identify a person during the use of the alert system 16 by this person.

The identification of the person using the alert system 16 makes it possible to avoid inappropriate use of the alert system 16 to generate false alert signals.

The identification module 36 is for example configured to identify the person generating an alert signal from data provided by the capture device 24 and/or the biometrics module 34.

Each pay station 4 optionally comprises an alert broadcasting device configured to emit a visual, audio and/or olfactory alert signal perceptible by pedestrians or passengers of vehicles near the pay station 4.

The alert broadcasting device for example comprises a signal generator 40 configured to generate a visual, audio and/or olfactory signal perceptible by a pedestrian or a passage of a vehicle located near the pay station 4. The signal generator 40 is carried by the pay station 4.

A signal generator 40 for generating a visual signal is for example chosen from among a flashing light, a projector for projecting an image on a surface, a hologram generator, a display screen, electro-chromatic paint covering the pay station, and a plurality of light sources.

A signal generator for generating a sound signal is for example chosen from among a speaker and a siren.

A signal generator for generating an olfactory signal is for example a fragrance diffuser.

Preferably, the signal generator 40 is separate from the man-machine interface device 10 and the payment device 12.

Each pay station 4 optionally comprises a communication device 42 configured to send the alert message wirelessly or optically, such that the alert message can be received by an electronic device of a pedestrian, a vehicle passenger or a vehicle located near the pay station 4.

The communication device 42 is configured to establish a communication link with at least one electronic device 44 of a pedestrian, a vehicle passenger or a vehicle located near the pay station 4.

A “communication link” here refers to a communication in which the communication device 42 and the electronic device 44 communicate directly with one another via the communication link, without going through a telecommunications network or a telecommunications device. The signals emitted by the communication device 42 are received directly by the electronic device 44 and vice versa.

The communication device 42 is for example configured for radiocommunication, for example according to a Bluetooth®, WIFI®, Lora, Beacon, Sygfox, Zigbee, Z-Wave, ANT+, Dust, NFC communication protocol, and/or for wireless optical communication, for example using the IRDA, Li-Fi, etc. technology.

An electronic device 44 of a pedestrian or a passenger of a vehicle is for example a smartphone, a digital tablet or an electronic watch. An electronic device 44 of a vehicle is for example an on-board infotainment system.

Each pay station 4 comprises a message-sending module 46 configured to send an alert message to the computer system 6 when a pedestrian uses the alert system 16 of the pay station 4.

The message sending module 46 is configured to include an identifier of the pay station 4 in the alert message. This identifier can make it possible to identify the pay station 4 from which the alert message 4 has been sent, and therefore the location from which the alert message is coming. A civilian security team can then be sent directly to this pay station 4.

The message-sending module 46 is optionally configured to include audio content, video content and/or biometric data provided by the capture device 24 and/or the biometrics module 34 in the alert message.

When the pay station 4 comprises an emergency call device 32, the alert message emitted by the pay station 4 and received by the computer system 6 makes it possible to trigger the establishment of the audio and/or video communication with a remote operator.

The computer server 6 comprises a broadcast module 48 configured to send an alert message coming from a pay station 4 to one or several predetermined recipients.

The predetermined recipients are recipients who may intervene following the alert message and/or recipients who may alert the people located near the pay station 4 from which the alert message originates, for example so that they are vigilant.

The broadcast module 48 is for example configured to broadcast the alert message to one or several road traffic data provider(s) 50 sending road traffic data to on-board electronic devices 52 in vehicles 54.

Road traffic data for example comprises the location of traffic jams, the presence of roadwork, the presence of radars, the passage of a priority vehicle, the speed limit, etc.

Each road traffic data provider 50 for example broadcasts the road traffic data via a radio signal sent to the vehicles equipped with an on-board electronic device 52 capable of capturing this radio signal, for example a geolocation receiver.

Each road traffic data provider 50 can for example broadcast the alert message to vehicles subscribing to this road traffic data provider 50 service, in order to notify them of the emitted alert and to encourage them to be vigilant.

Optionally or alternatively, the broadcast module 48 is configured to broadcast the alert message to one or several civilian security entities 56 responsible for public safety, emergency services and/or traffic.

Optionally or alternatively, the broadcast module 48 is configured to send the alert message to one or several pay station(s) 4 from among the other pay stations 4 of the management system 2, for the generation, by each pay station 4 receiving the alert message, of a visual, audio and/or olfactory alert signal by the signal generator 40 of this or these pay station(s) 4, and/or for the broadcast, by each pay station 4 receiving the alert message, of the alert message to electronic devices 44 of pedestrians or vehicles located near this or these pay station(s) 4 via the communication device 42 of this or these pay station(s) 4. The pay stations 4 can thus be used as a system for broadcasting alerts to pedestrians and/or vehicles located near the pay stations 4.

Each of the analysis module 26, the biometrics module 34, the identification module 36, the message-sending module 46 and/or the broadcast module 48 is for example a software module stored in a computer memory and executable by a processor, the computer memory and the processor belonging to a data processing unit.

In the illustrated example, the analysis module 26, the biometrics module 34, the identification module 36 and the message-sending module 46 are software modules stored in a memory 60 and executed by a processor 62 of a data processing unit 64 of the pay station 4. The broadcast module 48 is a software module stored in a memory 66 and executed by a processor 68 of a data processing module 70 of the computer system 6.

Alternatively, at least of the analysis module 26, the biometrics module 34, the identification module 36, the message-sending module 46 and the broadcast module 48 is provided in the form of a dedicated integrated circuit or programmable logic component.

Furthermore, in the illustrated example, an analysis module 26, a biometrics module 34 and an identification module 36 are present in each pay station 4.

Alternatively, the analysis module 26, the biometrics module 34 and/or the identification module 36 is (are) located in the computer system 6. This makes it possible to process the sounds, images and biometric data captured by several pay stations 4 in a centralized manner in the computer system 6. This can for example facilitate the maintenance of the pay stations 4 if an update of one of these modules is necessary, since the [update] does not have to be done on each pay station 4.

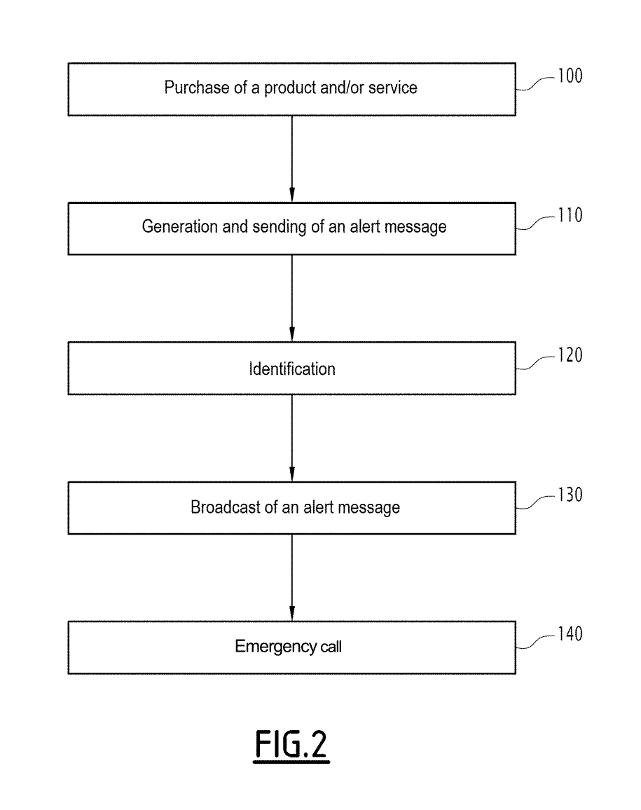

The operation of the management system 2 will now be described in reference to FIG. 2, showing a flowchart of an alert broadcasting method.

In a payment step 100, a user uses a pay station 4 of the management system 2 to purchase a product and/or service. The data necessary to carry out the transaction are stored locally in the pay station 4 and/or in the computer system 6. If necessary, to carry out the transaction, the pay station 4 communicates with the computer system 6 to exchange data, via the communication network 8 of the management system 2.

In the alert step 110, a pedestrian having witnessed or been the victim of an event uses the alert system 16 of the pay station 4 in order to generate an alert message. The pay station 4 generates the alert message and sends it automatically to the computer system 6.

In an optional identification step 120, the pedestrian using the alert system 16 of the pay station is identified, for example using the capture device 24 and/or the biometrics module 34.

In a broadcasting step 130, the computer system 6 sends, preferably automatically, the alert message to one or several predetermined recipients, for example one or several road traffic data providers 50, one or several civilian security entities 56 and one or several pay stations 4.

When the alert message is sent to other pay stations 4, the latter broadcast the alert message using their respective communication devices 42.

In an optional call step 140, the pedestrian is placed in audio and/or video communication with a remote operator, for example using data for information on the alert.

In the illustrated example, the identification step is carried out after the step for sending the alert message to the computer system 6. Alternatively, it may be done beforehand.

Furthermore, in the illustrated example, the call step is carried out after the identification step and the broadcasting step. Alternatively, the call step is carried out before an identification step and/or before a broadcasting step.

The pay stations 4 for purchasing a product and/or a service, located on the road and connected to a computer system 6, can constitute an effective medium for generating and sending an alert message by pedestrians having witnessed or been the victim of an event.

The pay stations 4 can be distributed geographically in a relatively dense mesh such that a pedestrian can quickly find a pay station 4.

The pay stations 4 already have the necessary infrastructure to communicate with the computer system 6 and for the supply of electricity.

The computer system 6 to which the pay stations 4 are connected allows the quick and effective broadcast of the alert message to predetermined recipients.

The pay stations 4 located near a pay station used to generate an alert message may further be used as warning terminals to generate an alert signal perceptible by pedestrians near the pay station 4 and/or broadcast locally to electronic devices located near the pay stations.

1. A self-service pay station arranged on a road to purchase a product and/or a service, the pay station being configured to be connected to a remote computer system connected to several similar pay stations of a system for managing a product and/or service, the pay station comprising an alert system configured to allow a pedestrian to generate an alert message, the pay station being configured to send the alert message to the computer system.

2. The pay station according to claim 1, wherein the alert system comprises an alert member able to be actuated manually by a pedestrian to generate an alert message.

3. The pay station according to claim 1, wherein the alert system comprises a touch-sensitive screen able to be used by a pedestrian to generate an alert message.

4. The pay station according to claim 1, wherein the alert system (16) comprises a capture device able to capture sounds, the pay station being configured to attach audio content to the alert message and/or to establish an audio communication with a remote operator.

5. The pay station according to claim 1, wherein the alert system comprises a capture device able to capture images, the pay station being configured to attach video content to the alert message and/or to establish a video communication with a remote operator.

6. The pay station according to claim 1, wherein the alert system comprises a biometrics module, the pay station being configured to determine biometric data, and to attach biometric data to the alert message and/or to identify a pedestrian using the alert system.

7. The pay station according to claim 1, comprising a signal generator configured to emit a visual, audio and/or olfactory alert signal perceptible by pedestrians and/or passengers of vehicles near the pay station.

8. The pay station according to claim 1, comprising a communication device configured to broadcast the alert message to electronic devices belonging to pedestrians, vehicle passengers and/or vehicles located near the pay station, via a radio or optical communication link.

9. A system for managing a product and/or service, comprising a plurality of pay stations according to claim 1, a computer system in communication with each pay station, the computer system being configured to broadcast each alert message sent by a pay station to one or several predetermined recipient(s).

10. The management system according to claim 9, wherein the predetermined recipient(s) are or comprise: one or several providers of road traffic data, one or several civilian safety entities and/or one or several pay stations from among the other pay stations of the management system.
